(19) United States
(12) Patent Application Publication
(10) Pub. No.: US 2005/0187305 A1
(43) Pub. Date: Aug. 25, 2005

(54) Solvent gelation using particulate additives

(76) Inventor: Robert G. Briell, Seguin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/786,560

(22) Filed: Feb. 25, 2004

(51) Int. Cl. C01B 33/20

(52) U.S. Cl. 516/110

(57) ABSTRACT

Enhanced viscosity of organic solvent systems may be accomplished by using particulate additives in combination with compatibilizers. In one embodiment, a compatibilizer is added to an organic solvent. A particulate additive is added to the compatibilizer/organic solvent system. Addition of the particulate additive to the compatibilizer/organic solvent system improves the viscosity of the organic solvent system.

### BACKGROUND

1. Field of the Invention

The present invention generally relates to additives for solvent borne rheological control applications. More particularly, the invention relates to additives to compatibilizer/solvent systems for solvent borne Theological control applications.

2. Description of Related Art

Traditionally, clay based gelators for solvent and solvent-borne applications are organically modified clays added under adequate shear conditions to the solvent system. A clay may include one or more individual platelets (e.g., layers) that may be intercalated. Upon intercalation, an interlayer spacing between the platelets may increase between the individual platelets. As used herein, “interlayer spacing” refers to a distance between internal faces of adjacent clay platelets as the clay platelets are assembled in a layered clay. “Intercalation,” as used herein, refers to the intrusion of an organic species between clay platelets, where the platelets are separated, but the ordered relationship between the platelets is maintained. Interlayer spacing may be measured by techniques generally known (e.g., x-ray diffraction).

Intercalation of clay platelets may be performed using ion exchange techniques. As used herein, the term “ion exchange” refers to the interchange of ions from one substance to another. A clay that undergoes intercalation may exhibit a cation exchange capacity of between about 50 to about 200 milliequivalents per 100 grams of the clay. Cation exchange capacity may be determined using generally known methods (e.g., ammonium acetate methods such as U.S. Environmental Protection Agency Method 9080).

In a conventional ion exchange process, a clay may be treated with water to “swell” the clay and thereby expand the d-spacing between the layers of the clay. The swollen clay is then treated with an intercalation agent that will render the resulting clay hydrophobic. For example, treatment of clay in water with a quaternary ammonium compound allows exchange of the cations of the clay with the cations of the quaternary ammonium compounds. The intercalated clay is then recovered and dried to produce an organoclay. After treatment with an intercalating agent, the organoclay materials are more compatible with organic systems.

Many commercially available organoclays may add color to the systems which creates an undesirable product in many applications. Furthermore, there are many solvent systems in which commercially available organoclays do not adequately perform. Finally, a formulator is unable to alter the concentration of the intercalator in the organoclay at the time of formulation. Instead, the formulator would have to request changes to the organoclay, and await production of the modified organoclay before testing the material in the formulation. This iterative process can significantly increase the formulation time of a product.

### SUMMARY

In an embodiment, an organogel may be formed by initially combining a compatibilizer with an organic solvent, to form a mixture of the compatibilizer with the organic solvent. A particulate additive may be added to the compatibilizer/organic solvent mixture. Addition of the particulate additive increases the viscosity of the organic solvent system.

Organogels may be formed, in this manner, for many different organic solvents. Examples of organic solvents include, but are not limited to: hydrocarbon solvents, aromatic hydrocarbon solvents, halogenated hydrocarbon solvents, ester solvents, ketone solvents, ether solvents, amine solvents, alcohol solvents, acid solvents, sulfides, amide solvents, nitroalkanes, arylnitro, nitriles, nitrogen heteroaromatic compounds, and silicone solvents.

Examples of compatibilizers include surfactants. Surfactants include cationic surfactants, anionic surfactants, amphoteric surfactants, and non-ionic surfactants. In one embodiment, the compatibilizer may include an onium compound. Examples of onium compounds include, but are not limited to cationic ammonium compounds, organophosphorus compounds and organosulfur compounds. In some embodiments, quaternary ammonium compounds may be used as a compatibilizer. Quaternary ammonium compounds having an organic portion derived from naturally occurring oils may be used for hydrocarbon solvents. In other embodiments, siloxane-quaternary ammonium compounds may be used for gelling of silicone solvents.

Particulate additives may include a variety of compounds that include, but are not limited to, polyacrylates, fumed silica, precipitated silica, natural and synthetic waxes, alkyl silicone waxes, aluminum silicate, lanolin derivatives, fatty alcohols, polyethylene copolymers, polyammonium stearate, sucrose esters, petrolatum, clays (e.g., phyllosilicates, hydrotalcites, layered double hydroxides, mixed metal hydroxides, etc.), fatty acids and derivatives thereof (e.g., fatty acid monoglyceride polyglycol ethers), polyvinylpyrrolidone and copolymers thereof, polyethylene imines, salts such as sodium chloride and ammonium sulfate, sucrose esters, and mixtures thereof.

In one embodiment, a particulate additive may include clays. Clays that may be useful include both natural and synthetic phyllosilicate clays. Smectite clays may include, but are not limited to, montmorillonite, beidellite, nontronite, saponite, hectorite, sauconite, stevensite, sepiolite, volkonskoite, magadiite, kenyaite and/or combinations thereof. A smectite-like mineral may include, but is not limited, to vermiculite, mica and/or synthetically prepared smectite-like mineral.

In another embodiment, an organogel may be formed by initially combining a particulate additive with an organic solvent, to form a mixture of the additive with the organic solvent. A compatibilizer may be added to the additive/organic solvent mixture. Addition of the compatibilizer to the additive/organic solvent mixture increases the viscosity of the organic solvent system.

### DETAILED DESCRIPTION

As used herein, “gel” generally refers to a mixture of a solvent and solid material network (such as a solid network of particle network, fibroid network, reticulated network, etc.) wherein the solid material (e.g., any solid such as a waxy material, polymeric material, sintered or fused particle material, or any other solid material that forms a physically supportive network for the other component) is formed through physical aggregation of the solid material through any associative means. Generally, a gel is more viscous than a liquid or paste, and retains its shape when left undisturbed (e.g., is self-supporting). However, a gel is typically not as hard or firm as a wax. Gels may be penetrated more easily than a wax-like solid, where “hard” gels are relatively more resistant to penetration than “soft” gels. A rigid gel as defined herein resists deformation upon the application of a force. A “hydrogel” generally refers to a gel in which the solvent (diluent) is water or aqueous based liquids. An “organogel” generally refers to a gel in which the solvent (diluent) is an organic carrier or organic solvent (as opposed to water or aqueous based liquids).

In some embodiments, a gel composition may include a compatibilizer, a particulate additive, and an organic solvent. The compatibilizer and the organic solvent may be combined and allowed to form a compatibilizer/organic solvent system. The compatibilizer/organic solvent system may be a mixture, a homogeneous solution, a dispersion, etc. of the compatibilizer in the organic solvent. One or more particulate additives may be combined with the compatibilizer/organic solvent system to form an organogel.

As used herein the term “organic solvent” refers to an organic molecule capable of at least partially dissolving another substance (i.e., the solute). Organic solvents may be liquids at room temperature. Examples of organic solvents that may be used to form organogels include, but are not limited to: hydrocarbon solvents (e.g., n-pentane, n-hexane, n-heptane, n-octane, paraffin, cyclohexane, methylcyclohexane, decahydronaphthalene, mineral oil, crude oils, etc.) which also includes aromatic hydrocarbon solvents (e.g., benzene, toluene, o-xylene, m-xylene, and p-xylene), halogenated hydrocarbon solvents (e.g., carbon tetrachloride, 1,2-dichloroethane, dichloromethane, chloroform, etc.), ester solvents (e.g., ethyl formate, methyl acetate, ethyl acetate, ethyl malonate, etc.), ketone solvents (e.g., acetone, methyl ethyl ketone, cyclohexanone, cyclopentanone, etc.), ether solvents (e.g., diethyl ether, dipropyl ether, diphenyl ether, tetrahydrofuran, 1,4-dioxane, etc.), amine solvents (e.g., propyl amine, diethylamine, triethylamine, aniline, pyridine), alcohol solvents (e.g., methanol, ethanol, 1-propanol, 1-butanol, 1-octanol, benzyl alcohol, phenol, trifluoroethanol, glycerol, ethylene glycol, propylene glycol, m-cresol, etc.), acid solvents (e.g., acetic acid, hexanoic acid, etc.), carbon disulfide, nitrobenzene, N,N-dimethylformamide, N,N,-dimethylacetamide, dimethyl sulfoxide, N-methyl-2-pyrrolidone, acetonitrile, silicone solvents (e.g., silicone oils, polysiloxanes, cyclosilicones). In some embodiments, two or more organic solvents may be combined to prepare an organogel.

In one embodiment, a silicone solvent may be a polysiloxane. In one embodiment, polysiloxanes have the general structure given below: 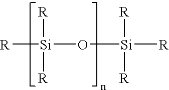
where each R is independently C1-C4 alkyl or phenyl, and n is 2 to 100. Examples of polysiloxane silicone solvents include polydimethylsiloxanes. Polydimethylsiloxanes are commercially available from Dow Corning, Midland, Mich. (e.g., Dow 200, Dow 555, Dow 2-1184, Dow 225, and Dow Q7-9120).

Other silicone solvents include cyclosiloxanes. Examples of cyclosiloxanes include compounds having the general structure: 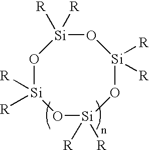
where each R is independently C1-C4 alkyl or phenyl, and n is 1 to 10. Examples of cyclosiloxanes include cyclomethicones (e.g., cyclotetrasiloxane, cyclopentasiloxane, cyclohexasiloxane). Cyclosiloxanes are commercially available from Dow Corning, Midland, Mich. (e.g., Dow 245, Dow 8500, Dow 246, Dow 345, and Dow 556, Dow 593, Dow 749, and Dow 2-8566).

A compatibilizer is a compound that interacts with both the organic solvent and the particulate additive. The interaction of the compatibilizer with the organic solvent and the additive allows the additive to increase the viscosity of the organic solvent. In one embodiment, a compatibilizer may be a surfactant. A surfactant, as used herein, is any compound that reduces the interfacial tension between two liquids or between a liquid and a solid. In general surfactants allow a solid or liquid, normally immiscible with a solvent, to become finely suspended within the solvent. Surfactants are typically divided into four classes: amphoteric, anionic, cationic, and non-ionic. The compatibilizing agent may be taken from any of these classes of surfactants. A number of organic salts may be used as compatibilizers. Examples of organic salts include anionic and cationic surfactants.

Anionic surfactants include molecules containing a negatively charged group attached to a substantially non-polar group. An example of an anionic surfactant includes aromatic hydrocarbon sulfonate salts. Examples of aromatic hydrocarbon sulfonate salts include, but are not limited to, ammonium xylene sulfonate, potassium xylene sulfonate, sodium toluene sulfonate, and sodium cumene sulfonate.

Nonionic surfactants include molecules that contain a substantially polar functional group attached to a substantially non-polar group. A preferred class of nonionic surfactant for use as a removing agent are the alkylphenol hydroxypolyoxyethylenes. The general structure of alkylphenol hydroxypolyoxyethylenes can be represented by formula (a). R may be hydrogen or a C₆-C₁₈ alkyl group. The alkyl group may be linear or branched. The value of n may be from 2-40. The R group is preferably C₈ or C₉. The value of n is preferably 6 to 10. Examples of alkylphenol hydroxypolyoxyethylenes include, but are not limited to, octylphenoxy polyethoxyethanol and nonylphenoxy polyethoxyethanol. Alkylphenol hydroxypolyoxyethylenes may be particular useful for the removal of paraffin embedding mediums by assisting in the formation of an emulsion of the paraffin wax within the composition. Generally, alkylphenol hydroxypolyoxyethylenes may aid the formation of emulsions by surrounding the paraffin particles to form a micelle.

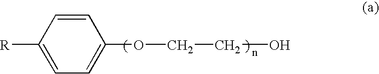

Another preferred class of nonionic surfactants for use as a removing agent is the polycarbohydrates. Polycarbohydrates include compounds that are composed of at least about 9 saccharide monomers, linked together by glycosidic bonds. An example of a polysaccharide is carrageenan. Carrageenan is a seaweed extract that is typically used as an emulsifier in food products. Polysaccharides may be particular useful for the removal of paraffin embedding mediums by assisting in the formation of an emulsion of the paraffin wax within the composition. Generally, polysaccharides may aid the formation of emulsions by coating the surfaces of the paraffin suspended within the composition, thus preventing them from coalescing.

Cationic surfactants include onium compounds. Onium compounds, as used herein refers to organic compounds that includes a Group VA element or a Group VIA element of the Periodic Table capable of forming one or more positive charges. Group VA and Group VIA elements include, but are not limited to, nitrogen, phosphorous or sulfur. Examples of onium compounds may include primary, secondary, tertiary and quaternary ammonium compounds, trisubstituted and pentasubstituted phosphonium compounds. Examples of multi-charged onium compounds may include tallow diamine, tallow alkylpentamethyl propylenediammonium, tris(2-hydroxyethyl)-N-tallowalkyl-1,3-diaminopropane, tallow triamine, and tallow tetramine. Multi-charged onium ions are described in U.S. Pat. No. 6,262,162 to Lan et al., which is incorporated by reference as if fully set forth herein. The anion associated with the onium compound may be a halogen or a polyatomic anion (e.g., methyl sulfate anion).

Onium compounds may include a Group VA or Group VIA element with sufficient organic groups bond to the element to produce a positively charged molecule. The organic portion of the onium compound may include, but is not limited to, alkyl groups, aromatic groups, alkylaryl groups, cyclic groups and/or cyclic heteroatom groups. Alkyl groups may be derived from, but are not limited to, petrochemical processes (e.g., α-olefins), animal oils, animal fats, natural oils, vegetable oils or combinations thereof. Examples of oils include tallow oil, soybean oil, coconut oil, castor oil, corn oil, cottonseed oil and/or palm oil.

Examples of aromatic groups may include, a benzyl group, a substituted benzyl group, a benzyl-type material and/or a benzylic-type material derived from a benzyl halide, a benzhydryl halide, a trityl halide, or an α-halo-α-phenylalkane. An alkane portion of the α-halo-α-phenylalkane may have an average carbon atom number ranging from 1 to 30. Examples of α-halo-α-phenylalkanes include, 1-halo-1-phenyloctadecane, substituted benzyl moieties, (e.g., derived from ortho-, meta- and para-chlorobenzyl halides), para-methoxybenzyl halides, ortho-nitrilobenzyl halide, meta-nitrilobenzyl halide, para-nitrilobenzyl halide ortho-alkylbenzyl halides, meta-alkylbenzyl halides, para-alkylbenzyl halides and/or fused ring benzyl-type moieties. An average carbon atom number of the alkyl portion of the alkylbenzyl halides may range from 1 to 30. A fused ring benzyl-type moiety may be derived from 2-halomethylnaphthalene, 9-halomethylanthracene and/or 9-halomethylphenanthrene. The halo portion of the fused ring precursor may include, but is not limited to, chloro, bromo and/or any other group that may serve as a leaving group in a nucleophilic attack of the benzyl-type moiety such that the nucleophile replaces the leaving group on the benzyl-type moiety.

Examples of other aromatic groups may include, a phenyl group, an alkyl phenyl group, a N-alkyl aniline group, a N,N-dialkyl aniline group, an ortho-nitrophenyl group, a meta-nitrophenyl group and para-nitrophenyl group. Examples of alkyl phenyl groups may include ortho-alkyl phenyl group, a meta-alkyl phenyl group and a para-alkyl phenyl group. An average carbon atom number for the alkyl portion of the alkyl phenyl group may range from 1 to 30. Additional examples of aromatic groups may include 2-halophenyl, 3-halophenyl or 4-halophenyl. The halo group may be, but is not limited to, chloro, bromo or iodo. Further examples of aromatic groups may include 2-carboxyphenyl, 3-carboxyphenyl and 4-carboxyphenyl and/or esters thereof. The alcohol portion of the ester may be derived from an alkyl alcohol. The alkyl portion of the alkyl alcohol may have an average carbon atom number ranging from 1 to 30. The alkyl portion of the alkyl alcohol may include, but is not limited to, phenol, benzyl alcohol moieties; and/or fused ring aryl moieties (e.g., naphthalene, anthracene, and phenanthrene).

Examples of cyclic heteroatom groups may include pyrrole, imidazole, thiazole, oxazole, pyridine, pyrimidine, quinoline, isoquinoline, indole, purine, benzimidazole, benzothiazole, benzoxazole, pyrazine, quinoxaline, quinazoline, acridine, phenazine, imidazopyridine and/or dipyridyl.

In one embodiment, a quaternary ammonium compound may be used as a compatibilizer. In an embodiment, a quaternary ammonium compound may be represented by a general chemical formula of: 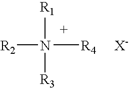
R₁, R₂, R₃ and R₄ represent an alkyl group, an aryl group, an arylalkyl group or combinations thereof. X represents an anion. Alkyl groups may include, but are not limited to, a saturated straight chain alkyl group, a saturated branched-chain alkyl group, an unsaturated branched-chain alkyl group, an unsaturated straight chain alkyl group, or combinations thereof. Alkyl groups may have an average carbon atom number ranging from 1 to 30. Aryl groups may have an average carbon atom number ranging from 7 to 22. Arylalkyl groups may have an average carbon atom number ranging from 7 to 22. The anion may include, but is not limited to, chloride, bromide, iodide, nitrite, hydroxide, nitrate, sulfate, methyl sulfate, halogenated methyl compounds or C₁ to C₁₈ carboxylate compounds acetate, phosphate or mixtures thereof. Alkyl quaternary ammonium compounds may include, but are not limited to, dimethyl di(hydrogenated tallow) ammonium chloride, methyl benzyl di(hydrogenated tallow) ammonium chloride, dimethyl benzyl hydrogenated tallow ammonium chloride, bis-hydroxyethyl methyl tallow ammonium chloride, dimethyl hydrogenated tallow-2-ethylhexyl ammonium methyl sulfate, methyl bis-2-hydroxyethyl stearyl ammonium chloride, dimethyl dibehenyl ammonium chloride and methyl tris(hydrogenated tailow) ammonium chloride.

Specific examples of quaternary ammonium compounds include: Dimethyl di(hydrogenated tallow) ammonium chloride (2M2HT), which is represented by the chemical formula: 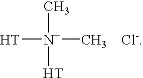
HT represents hydrogenated tallow;
Methyl bis-2-hydroxyethyl stearyl ammonium chloride (M₂HES) which is represented by the chemical formula: 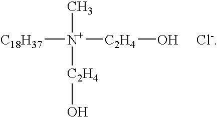
Dimethyl dibehenyl ammonium chloride, which is represented by the chemical formula:

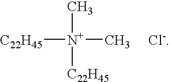

Methyl tris(hydrogenated tallow alkyl) chloride, which is represented by the chemical formula: 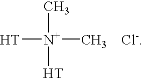
HT represents hydrogenated tallow.

In another embodiment, siloxane-quaternary ammonium compounds may be used as a compatibilizer. Siloxane-quaternary ammonium compounds may be useful for gelling a wide variety of organic solvents including silicone solvents. In one embodiment, siloxane-quaternary ammonium compounds have the general structure: 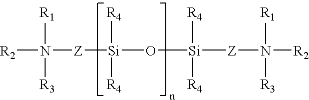
where R₁, R₂, R₃, are independently alkyl groups, aryl groups, arylalkyl groups, alkyl alcohols, alkyl amines, or alkyl amides and wherein each R₄ is independently methyl or hydrogen, and wherein n is 2-100, and wherein Z is an alkyl, aryl arylalkyl, alkyl alcohol, or ether group linking the amine functionality to the siloxane functionality. Examples of siloxane-quaternary ammonium compounds having this structure include, but are not limited to ABIL Quat 3272 and ABIL Quat 3474 available from Degussa.

Particulate additives may include a variety of compounds that include, but are not limited to, polyacrylates, fumed silica, precipitated silica, natural and synthetic waxes, alkyl silicone waxes, aluminum silicate, lanolin derivatives, fatty alcohols, polyethylene copolymers, polyammonium stearate, sucrose esters, clays, petrolatum, hydrotalcites, layered double hydroxides, mixed metal hydroxides, fatty acids and derivatives thereof (e.g., fatty acid monoglyceride polyglycol ethers), polyvinylpyrrolidone and copolymers thereof, polyethylene imines, salts such as sodium chloride and ammonium sulfate, sucrose esters, and mixtures thereof.

In one embodiment, a particulate additive may include clays. Clays that may be useful include both natural and synthetic phyllosilicate clays. As used herein, the term “clay” refers to any expanding clay mineral with hydroxyl functionality, expanding clay-like mineral with hydroxyl functionality or combinations thereof. Expanding clays may include, but are not limited to, smectite, smectite-like mineral, a smectite-like cationic mineral and/or combinations thereof. As used herein, the term “smectite” or “smectite-like clay” refers to a clay with an expandable crystal lattice. Smectite clays may include, but are not limited to, montmorillonite, beidellite, nontronite, saponite, hectorite, sauconite, stevensite, sepiolite, volkonskoite, magadiite, kenyaite and/or combinations thereof. A smectite-like mineral may include, but is not limited, to vermiculite, mica and/or synthetically prepared smectite-like mineral. Synthetic smectite clays are described in U.S. Patent Application No. 20030095906 entitled “SYNTHETIC CLAY COMPOSITIONS AND METHODS FOR MAKING AND USING” which is incorporated herein by reference. Synthetic smectite clays include Laponite, which is commercially available from Southern Clay Products, Gonzales, Tex.

Montmorillonite may be represented by the following chemical formula, (Si₈₋ₓAlₓ)(Al_{4-y}(Ti, Fe, Mg)_{y}O₂₀(OH)₄R⁺_{x+y}, where 0≦x≦0.4; 0.55≦y≦1.10 and R represents Na⁺, Li⁺, NH₄⁺ and/or combinations thereof. Cloisite Na⁺ is an example of a Wyoming montmorillonite.

Hectorite may be represented by a general chemical formula of: (Mg₆₋ₓLiₓ)Si₈O₂₀(OH, F)₂Rₓ⁺, where 0.57≦x≦1.15; and R represents Na⁺, Li⁺, NH₄⁺ and/or combinations thereof.

Saponite may be represented by a general chemical formula of: (Si₈₋ₓAlₓ)(Mg, Fe)₆O₂₀(OH)₄Rₓ⁺, where 0.58≦x≦1.84; and R represents Na⁺, Li⁺, NH₄⁺ and/or combinations thereof.

Stevensite may be represented by the general chemical formula of: [Mg₆₋ₓSi₈O₂₀(OH)₄]R⁺₂ₓ, where 0.28≦x≦0.57; and R represents Na⁺, Li⁺, NH₄⁺ and/or combinations thereof.

Beidellite may be represented by the general chemical formula of: [Al₄(Si₈₋ₓAlₓ)O₂₀(OH)₄]R⁺ₓ, where 0.55≦x≦1.10; and R represents Na⁺, Li⁺, NH₄⁺ and/or combinations thereof.

In certain embodiments, a clay may be converted to a sodium form prior to being used as a particulate additive. Conversion of the clay to the sodium form may be performed by preparing an aqueous clay slurry. The aqueous clay slurry may be contacted with a sodium exchange resin using general techniques (e.g., fluid bed reactors, ion exchange columns). As the aqueous clay contacts the sodium exchange resin, sodium cations are exchanged for cations in the clay. In other embodiments, a clay may be mixed with water and a soluble sodium compound to perform an ion exchange. The resulting ion exchanged mixture may be sheared using generally known processes (e.g., a Manton-Gaulin homogenizer, a colloid mill). Examples of soluble sodium compounds may include water-soluble sodium salts (e.g., sodium carbonate, sodium hydroxide, sodium sulfate and/or combinations thereof).

A gel may be prepared by adding a particulate additive to a compatibilizer/organic solvent system. The compatibilizer/organic solvent system may be formed by mixing compatibilizer and solvent to form a homogeneous solution, a mixture, or a dispersion. Mixing of the compatibilizer/organic solvent system may be accomplished with, for example, an ultrasonic reactor. Particulate additives may be added to the compatibilizer/organic solvent system. The particulate matter and the compatibilizer/organic solvent system may be mixed (e.g., with an ultrasonic reactor or other mixing device) to form gel.

In an alternate embodiment, a gel may be prepared by adding a compatibilizer to a particulate additive/organic solvent system. The particulate additive/organic solvent system may be formed by mixing a particulate additive and solvent to form a dispersion of the particulate additive in the solvent. One or more compatibilizers may be added to the particulate additive/organic solvent system. The addition of the compatibilizer(s) to the particulate additive/organic solvent system may cause the mixture to become a gel.

### EXAMPLES

### Example 1

1.98 g of 2M2HT (MW=570, 82% activity) was added to 30 grams of toluene in a 50 ml vial and subjected to about 10 seconds on an HRV ultrasonic reactor (Advanced Sonic Processing Systems, Model no. HRV-6×32-2072). 3.0 g of sodium montmorillonite (CEC=95) was added to the vial. The vial was hand shaken and then placed in the HRV for about 15 minutes. The system formed a stiff gel with a greenish tint. No movement of the gel was noted, even after the vial was inverted for several minutes.

### Example 2

A sample was prepared in the same manner as Example 1, except 2M2HT was not added. The sodium montmorillonite settled to the bottom of the vial. No gellation was noted.

### Example 3

A sample was prepared in the same manner as Example 1, except odorless mineral spirits (OMS) was used in place of toluene. The 2M2HT did not go in solution in the OMS, but no separation was noted upon standing.

### Example 4

A sample was prepared in the same manner as Example 1, except Laponite® RD was used in place of sodium montmorillonite. A white, opaque gel was formed. The gel did not flow during inversion of the vial.

### Example 5

A sample was prepared in the same manner as Example 1, except OMS was used in place of toluene and Laponite® RD was used in place of sodium montmorillonite. A white, opaque gel was formed. The gel did not flow during inversion of the vial.

Table 1 is a tabulation of viscosities of smectite/onium compound/toluene organogels measured on a Brookfield RVTDCP viscometer (GP42 and GP52 spindles) at 10, 20, 50, and 100 rpm. A compatibilizer/solvent system was prepared with 2M2HT and toluene. The 2M2HT was added to 30 grams of toluene. An amount of 2M2HT added for each sample was determined using the amount of smectite to be added, the CEC of the smectite, and the activity of 2M2HT. For example, for a Laponite RD (Southern Clay Products) concentration of 10 pph, 1.25 g of 2M2HT was added to 30 grams of toluene.

TABLE 1

| | | | | Viscosity (cps) | | | |
|---|---|---|---|---|---|---|---|
| | Particulate | Conc. | | 10 | 20 | 50 | 100 |
| Sample | Additive | (pph) | Spindle | rpm | rpm | rpm | rpm |
| 1 | Laponite ® RD | 2 | GP42 | 45 | 16 | 9 | 5 |
| 2 | Laponite ® RD | 4 | GP52 | 885 | 344 | 197 | 118 |
| 3 | Laponite ® RD | 10 | GP52 | 8356 | 4620 | — | — |

The data in Table 1 indicate that solvent viscosity is increased with addition of the compatibilizer and particulate additive as described. Increased concentration of the particulate additive was shown to increase viscosity of the produced organogels. Dashes indicate a viscosity that exceeded measurement capacity of the viscometer.

In some embodiments, silicone oil may be used as a solvent in an organogel. In the experiments summarized in Table 2, organogels were made with 20 g of Dow Corning 245, a low viscosity cyclomethicone fluid, ABIL Quat 3474 (Goldschmidt/Degussa, MW≅7000), and Laponite® RD (particulate additive). Organogel sample 1 was prepared in substantially the same manner as samples 1-3 in Table 1. Viscosities for organogel sample 1 was measured with a Brookfield RVTDCP viscometer.

TABLE 2

| | | Particulate | ABIL | Viscosity (cps) | | |
|---|---|---|---|---|---|---|
| | Particulate | Additive | Quat | 10 | 20 | 50 |
| Sample | Additive | (g) | 3474 (g) | rpm | rpm | rpm |
| 1 | Laponite ® RD | 1.00 | 5.80 | 9437 | 4718 | 1887 |

The weight ratio of Laponite® RD to ABIL Quat 3474 in sample 1 (1.0:5.88) corresponds to the flocculation point of Laponite® RD/ABIL Quat 3474.

Samples 1-4 in Table 3 are similar to sample 1 in Table 2, with 20 g of Dow Corning 245, ABIL Quat 3474, and lower levels of Laponite® RD. Viscosity measurement with an RV viscometer allowed measurement of higher viscosities than the Brookfield RVTDCP.

TABLE 3

| | | Particulate | ABIL | Viscosity (cps) | | | |
|---|---|---|---|---|---|---|---|
| | Particulate | Additive | Quant | 10 | 20 | 50 | 100 |
| Sample | Additive | (g) | 3474 (g) | rpm | rpm | rpm | rpm |
| 1 | Laponite ® RD | 0.75 | 2.0 | 4500 | 4500 | 4500 | 4000 |
| 2 | Laponite ® RD | 0.75 | 2.5 | 16000 | 15000 | 13800 | — |
| 3 | Laponite ® RD | 0.75 | 3.0 | 18000 | 17250 | 16200 | — |
| 4 | Laponite ® RD | 0.75 | 3.5 | 32500 | 32000 | — | — |

In this patent, certain U.S. patents and U.S. patent applications have been incorporated by reference. The text of such U.S. patents and U.S. patent applications is, however, only incorporated by reference to the extent that no conflict exists between such text and the other statements and drawings set forth herein. In the event of such conflict, then any such conflicting text in such incorporated by reference U.S. patents and U.S. patent applications is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes can be made in the elements described herein without departing from the spirit and scope of the invention as described in the following claims. In addition, it is to be understood that features described herein independently may, in certain embodiments, be combined.

1. A method of making an organogel comprising:
combining a compatibilizer with an organic solvent to form a mixture of the compatibilizer in the organic solvent;
adding a particulate additive to the compatibilizer-organic solvent mixture, wherein addition of the particulate additive increases the viscosity of the compatibilizer-organic solvent mixture to form the organogel.

2. The method of claim 1, wherein the compatibilizer comprises one or more surfactants.

3. The method of claim 1, wherein the compatibilizer comprises one or more organic salts.

4. The method of claim 1, wherein the compatibilizer comprises one or more cationic surfactants.

5. The method of claim 1, wherein the compatibilizer comprises one or more cationic surfactants, and wherein the particulate additive comprises one or more cations capable of exchanging with one or more of the cationic surfactants.

6. The method of claim 1, wherein the compatibilizer comprises one or more anionic surfactants.

7. The method of claim 1, wherein the compatibilizer comprises one or more anionic surfactants, and wherein the particulate additive comprises one or more anions capable of exchanging with one or more of the anionic surfactants.

8. The method of claim 1, wherein the compatibilizer comprises one or more non-ionic surfactants.

9. The method of claim 1, wherein the compatibilizer comprises one or more amphoteric surfactants.

10. The method of claim 1, wherein the compatibilizer comprises one or more quaternary ammonium compounds.

11. The method of claim 1, wherein the particulate additive comprises one or more clays.

12. The method of claim 1, wherein one or more of the clays comprise one or more phyllosilicates.

13. The method of claim 1, wherein the particulate additive comprises one or more smectite clays.

14. The method of claim 1, wherein the particulate additive comprises one or more synthetic phyllosilicate clays.

15. The method of claim 1, wherein the particulate additive comprises hydrotalcite.

16. The method of claim 1, wherein the particulate additive comprises one or more fatty acids or fatty acid derivatives.

17. The method of claim 1, wherein the particulate additive comprises one or more polyacrylates.

18. The method of claim 1, wherein the particulate additive comprises one or more polyethylene glycols.

19. The method of claim 1, wherein the particulate additive comprises silica.

20. The method of claim 1, wherein the particulate additive comprises one or more carbohydrates or polycarbohydrates.

21. The method of claim 1, wherein the organic solvent comprises a hydrocarbon solvent.

22. The method of claim 1, wherein the organic solvent comprises a siloxane solvent.

23. The method of claim 1, wherein the organic solvent comprises a halogenated hydrocarbon solvent.

24. The method of claim 1, wherein the organic solvent comprises an ester solvent.

25. The method of claim 1, wherein the organic solvent comprises an aromatic hydrocarbon solvent.

26. The method of claim 1, wherein the organic solvent comprises a ketone solvent.

27. The method of claim 1, wherein the organic solvent comprises an amine solvent.

28. The method of claim 1, wherein the organic solvent comprises an ether solvent.

29. The method of claim 1, wherein the organic solvent comprises an alcohol solvent.

30. The method of claim 1, wherein the organic solvent comprises a mixture of two or more of: a hydrocarbon solvent, a halogenated hydrocarbon solvent, a siloxane solvent, a ketone solvent, an ester solvent, an ether solvent, an amine solvent, and an alcohol solvent.

31. The method of claim 1, wherein the organogel comprises between about 0.1 wt % to about 10 wt % of the particulate additive.

32. The method of claim 1, wherein the compatibilizer is soluble in the organic solvent.

33. A method of making an hydrocarbon organogel comprising:
combining one or more quaternary ammonium compounds with a hydrocarbon solvent to form a mixture of the one or more quaternary ammonium compounds in the hydrocarbon solvent;
adding one or more clays to the quaternary ammonium compounds-hydrocarbon solvent mixture, wherein addition of one or more clays increases the viscosity of the quaternary ammonium compounds-hydrocarbon solvent mixture to form the hydrocarbon organogel.

34. The method of claim 33, wherein one or more clays comprise one or more cations capable of exchanging with one or more of the quaternary ammonium compounds.

35. The method of claim 33, wherein one or more of the quaternary ammonium compounds have the structure: 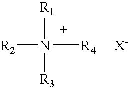
wherein R₁, R₂, R₃, and R₄ are independently alkyl groups, aryl groups or arylalkyl groups, and wherein at least one of R₁, R₂, R₃, or R₄ is an aliphatic group derived from a naturally occurring oil.

36. The method of claim 33, wherein one or more of the quaternary ammonium compounds have the structure: 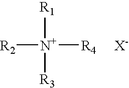
wherein R₁, R₂, R₃, and R₄ are independently alkyl groups, aryl groups or arylalkyl groups, and wherein at least one of R₁, R₂, R₃, or R₄ is an aliphatic group derived from tallow.

37. The method of claim 33, wherein one or more of the clays comprise one or more smectite clays.

38. The method of claim 33, wherein one or more of the clays comprise one or more phyllosilicates.

39. The method of claim 33, wherein one or more of the clays comprise one or more synthetic phyllosilicate clays.

40. The method of claim 33, wherein one or more of the clays comprise hydrotalcite.

41. The method of claim 33, wherein one or more of the clays comprise a montmorillonite.

42. The method of claim 33, wherein one or more of the clays comprise a synthetic layered silicate.

43. The method of claim 33, wherein the hydrocarbon solvent comprises an aromatic hydrocarbon.

44. The method of claim 33, wherein the hydrocarbon solvent further comprises one or more of: a hydrocarbon solvent, a halogenated hydrocarbon solvent, a siloxane solvent, a ketone solvent, an ester solvent, an ether solvent, an amine solvent, and an alcohol solvent.

45. The method of claim 33, wherein the organogel comprises between about 0.1 wt % to about 10 wt % of the clay.

46. The method of claim 33, wherein one or more quaternary ammonium compounds are soluble in the hydrocarbon solvent.

47. The method of claim 33, wherein the hydrocarbon solvent comprises toluene and wherein the at least one quaternary ammonium compound comprises a hydrogenated tallow quaternary ammonium compound, and wherein at least one clay comprises a phyllosilicate clay.

48. A method of making a silicone organogel comprising:
combining one or more quaternary ammonium compounds with a silicone solvent to form a mixture of the one or more quaternary ammonium compounds in the silicone solvent;
adding one or more clays to the quaternary ammonium compounds-silicone solvent mixture, wherein addition of one or more clays increases the viscosity of the quaternary ammonium compounds-silicone solvent mixture to form the silicone organogel.

49. The method of claim 48, wherein one or more clays comprise one or more cations capable of exchanging with one or more of the quaternary ammonium compounds.

50. The method of claim 48, wherein one or more of the quaternary ammonium compounds comprises a polysiloxane quaternary ammonium compound.

51. The method of claim 48, wherein one or more of the quaternary ammonium compounds have the structure: 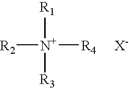
wherein R₁, R₂, R₃, and R₄ are independently alkyl groups, aryl groups or arylalkyl groups, and wherein at least one of R₁, R₂, R₃, or R₄ is a polysiloxane group.

52. The method of claim 48, wherein one or more of the quaternary ammonium compounds have the structure: 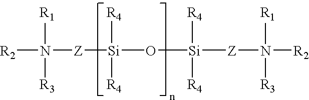
wherein R₁, R₂, R₃, are independently alkyl groups, aryl groups, arylalkyl groups, alkyl alcohols, alkyl amines, or alkyl amides and wherein each R₄ is independently methyl or hydrogen, and wherein n is 2-100, and wherein Z is an alkyl, aryl arylalkyl, alkyl alcohol, or ether group linking the amine functionality to the siloxane functionality.

53. The method of claim 48, wherein one or more of the clays comprise one or more smectite clays.

54. The method of claim 48, wherein one or more of the clays comprise one or more phyllosilicates.

55. The method of claim 48, wherein one or more of the clays comprise one or more synthetic phyllosilicate clays.

56. The method of claim 48, wherein one or more of the clays comprise hydrotalcite.

57. The method of claim 48, wherein one or more of the clays comprise a montmorillonite.

58. The method of claim 48, wherein one or more of the clays comprise a synthetic layered silicate.

59. The method of claim 48, wherein the silicone solvent comprises a polysiloxane solvent.

60. The method of claim 48, wherein the silicone solvent comprises a polysiloxane solvent having the formula: 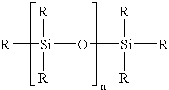
where each R is independently C1-C4 alkyl and n is 2 to 100.

61. The method of claim 48, wherein the silicone solvent comprises a cyclosiloxane solvent.

62. The method of claim 48, wherein the silicone solvent comprises a cyclosiloxane solvent having the formula: 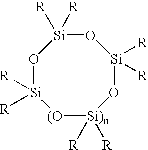
where each R is independently C1-C4 alkyl or phenyl, and n is 1 to 10.

63. The method of claim 48, wherein the silicone solvent further comprises one or more of: a hydrocarbon solvent, a halogenated hydrocarbon solvent, a ketone solvent, an ester solvent, an ether solvent, an amine solvent, and an alcohol solvent.

64. The method of claim 48, wherein the organogel comprises between about 0.1 wt % to about 10 wt % of the clay.

65. The method of claim 48, wherein one or more quaternary ammonium compounds are soluble in the silicone solvent.

66. The method of claim 48, wherein the silicone solvent comprises a cyclosiloxane solvent and wherein the at least one quaternary ammonium compound comprises a polysiloxane quaternary ammonium compound, and wherein at least one clay comprises a phyllosilicate clay.

67. An organogel made by the process comprising:
combining a compatibilizer with an organic solvent to form a mixture of the compatibilizer in the organic solvent;
adding a particulate additive to the compatibilizer-organic solvent mixture, wherein addition of the particulate additive increases the viscosity of the compatibilizer-organic solvent mixture to form the organogel.

68-69. (canceled)

70. A method of making an organogel comprising:
combining a particulate additive with an organic solvent to form a mixture of the particulate additive in the organic solvent;
adding a compatibilizer to the particulate additive-organic solvent mixture, wherein addition of the compatibilizer increases the viscosity of the particulate additive-organic solvent mixture to form the organogel.

71-138. (canceled)
